(19) United States
(12) Patent Application Publication
(10) Pub. No.: US 2023/0173962 A1
(43) Pub. Date: Jun. 8, 2023

(54) Seat heating control for a vehicle

(71) Applicant: Sarkis Allen Arzoumanian, Glendale, CA (US)

(72) Inventor: Sarkis Allen Arzoumanian, Glendale, CA (US)

(21) Appl. No.: 17/803,808

(22) Filed: Dec. 2, 2022

Related U.S. Application Data
(60) Provisional application No. 63/361,181, filed on Dec. 3, 2021.

(51) Int. Cl. B60N 2/56; H05B 1/02

(52) U.S. Cl. CPC B60N 2/5678; H05B 1/0238

(57) ABSTRACT

A seat heater for a motor vehicle is shown and described. An electronic controller receives input signals from a manual switch controlling separate seat and seatback heating elements. One type of signal, such as that resulting from one depression of the switch, effects energizing of both seat and also seatback heating elements. A second type of signal, such as two depressions of the switch, effects energizing of only the seatback heating element. The input signals provide operating power to the electronic controller. Optionally, energizing of the seatback heating element may be stopped should any other pattern of switch operation occur. Optionally, energizing of only the seatback heating element may be indicated audibly, visibly, or both. Optionally, energizing of only the seatback heating element may be limited to a predetermined time interval.

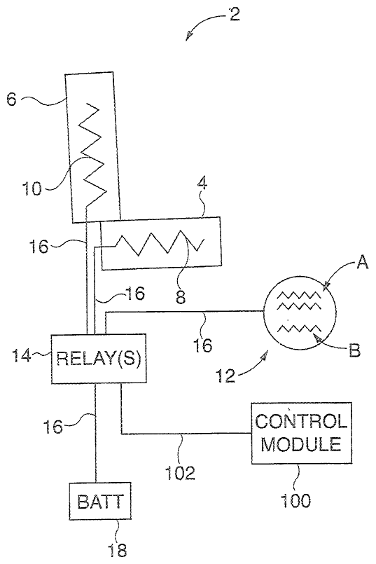

### REFERENCE TO RELATED APPLICATION

This application claims priority to Ser. No. 63/361,181, filed Dec. 3, 2021.

### FIELD OF THE INVENTION

The present invention relates to electrically heated seats for motor vehicles, and more particularly, to selective control of seat heating.

### BACKGROUND OF THE INVENTION

Luxury amenities in motor vehicles may include heated seats and seatbacks. These may be heated by a manually operated switch accessible to a passenger of a heated seat.

Some people have discomfort or pain due to back problems. This discomfort or pain may be alleviated for many people by applying heat to the back. This may be highly desirable to passengers in motor vehicles, who have such back problems. However, it will frequently be the case that also heating the seat is undesirable.

There exists a need for seat heating controls which selectively enable back-only heating, while inhibiting seat heating. It is also desirable to minimize redesign and modification of a motor vehicle to accommodate selective seat heating control.

### SUMMARY OF THE INVENTION

The present invention meets the above needs by providing a control which can operate seatback heating without also operating seat heating. This can be done while continuing to use a pre-existing switch for seat heating control. This avoids onerous rewiring of the seat heating system. A novel electronic control module is wired into a new or existing wiring system to control seat heating. By considering the number of command signals entered into the pre-existing seat heating control switch within a predetermined time interval, the control module issues appropriate control signals to operate seat heating conventionally, or alternatively, to operate only seatback heating while inhibiting bottom seat heating.

Thus, seatback heating for treatment of back problems is enabled, using the same manual switch and circuit relays originally provided for new or conventional seat and seatback heating.

The novel system may be further modified to include audible or visible confirmation of seatback heating (or both audible and visible confirmation).

Optionally, the novel system may include timing limitation features to provide seatback heating for a predetermined time interval only, or to discontinue seat heating after a seat occupant has left, to avoid draining the battery.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWING

Various objects, features, and attendant advantages of the present invention will become more fully appreciated as the same becomes better understood when considered in conjunction with the accompanying drawing, and wherein the Figure is a diagrammatic representation of vehicle components and controls therefor.

### DETAILED DESCRIPTION

Referring to the Figure, according to at least one aspect of the invention, there is shown a vehicle seat 2 including a seat 4 and a seatback 6. Seat 4 is heated by a seat heating element 8, while seatback 6 has a seatback heating element 10. Heating elements 8 and 10 are connected to power from a manual switch 12 having a high heating level A and a low heating level B. Switch 12 causes relays (not individually shown) in a relay array 14 to connect power through circuitry 16 from a battery 18 of the motor vehicle (not shown it its entirety).

The components described thus far are known, and need not be further detailed herein. Circuitry 16 will be understood to include that number of conductors, connections, and supplementary components necessary to effect operation as described.

Relay array 14 includes at least one or two relays connecting battery power to seat heating element 8 and seatback heating element 10. Relay array 14 may be in one location, or alternatively, its constituent individual relays (not separately shown) may be remote from each other.

An electronic control module 100 is connected to the known circuitry and/or components by circuitry 102. Control module 100 will be understood to include a microprocessor, memory, timer, counter, and other known or standard components (none indidvidually shown) as required to effect operation as described herein. Circuitry 102 will be understood to include a number of conductors, connections, and supplementary components as necessary to enable operation as described.

Control module 100 works by considering the number of commands entered into a new or pre-existing seat heating control switch 12 within a predetermined time period as input signals. For example, a single depression of switch 12 in two seconds may be used to effect conventional seat and seatback heating via relays in relay array 14. Two depressions of switch 12 within two seconds may be used to effect seatback heating while inhibiting seat heating.

An optional advantageous feature of the invention is that the electronic controller can exploit input signals to obtain operating power. No dedicated power wiring is necessary to provide operating power to the electronic controller. Control module 100 may include a capacitor (not separately shown) connected to store energy from a first input signal from switch 12 to provide operating power when no input signal is available to maintain operation.

Novel control module 100 may also be used to automatically time seat heating, discontinuing heating after either a predetermined or an adjustable time period. For example, a timer (not separately shown) incorporated into control module 100 to limit how long seat heating operates. Alternatively, control module 100 may be connected to a seat occupancy sensor (not shown) such that after a predetermined time interval after the sensor reports that no occupant is using seat 2, heating will be discontinued.

The novel control system may incorporate an audible or visible indicator (neither shown) or both, to confirm system operation. A miniature buzzer may be incorporated into control module 100. Where the novel system is implemented during initial vehicle fabrication, a visual indicator such as an LED indicating light can be incorporated into the dashboard, door, armrest, or other portion (none shown) of the vehicle. Alternatively, the novel system may operate an existing indicating light. For example, control module 100 may issue a pulsed signal to the pre-existing indicating light. Used with indicating lights that ordinarily are constantly illuminated, the flashing effect from pulsed signals will differentiate use of the pre-existing indicator to signal seat heating operation from the usual condition monitored by that pre-existing indicator. Of course, both audible and visual indicators may be provided if desired.

Control module 100 may be programmed such that illogical or undefined switch operation cancels heating operation. For example, if a user uses switch 12 by entering commands repetitively (e.g., “off-high-off-high”), a counter (not separately shown) in control module 100 will cancel seat heating operation.

The present invention may be practiced in several ways. In a first scenario, components including control module 100 controlling an existing relay or alternatively, with an optional additional relay added, may be provided commercially by an entity other than the original manufacturer of the motor vehicle. In this case, the product would be sold as an aftermarket device by an aftermarket supplier. An aftermarket installer or a consumer buyer of the kit would then install the kit components and provide minor materials such as wiring, terminals, etc.

In a second scenario, components described above would be procured or manufactured by the original manufacturer of the vehicle, for installation either as a factory modification, or possibly as a dealer installed kit.

In a third scenario, the manufacturer could install the system during initial assembly of the motor vehicle. Installation under this scenario could utilize a software change within a pre-existing computer and possibly a modified manual user switch, and possibly a revised relay arrangement to accomplish independent energizing of heating elements 8 and 10.

In all three scenarios, independent operation of seat heating element 8 and seat back heating element 10 are at the discretion of a passenger occupying seat 2.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the specification and claims.

I claim:

1. A seat heating system for a motor vehicle, the seat heating system having
at least one seat further including a seat having a first heating element and a seatback having a separate, second heating element, a battery, a switch controlling operation of the first heating element and the second heating element, a battery, a relay array including a first relay electrically connected to the first heating element and a second relay electrically connected to the second heating element, and electrical circuitry operably connecting the first heating element, the second heating element, the relay array, the switch, and the battery; and
an electronic controller electrically connected to one of existing wiring and a said relay of the relay array and to the switch, the electronic controller having a microprocessor and software configured to accept power pulses from the switch and to energize the first heating element and the second heating element responsively to receiving a first signal type from the switch, and to energize only the second heating element responsively to receiving a second signal type from the switch, and circuitry connecting the electronic controller to individual relays of the relay array.

2. The seat heating system of claim 1, further comprising at least one of an audible indicator indicating seatback heating operation when the first heating element is not subject to heating operation and a visual indicator indicating seatback heating operation when the first heating element is not subject to heating operation.

3. The seat heating system of claim 1, wherein the first signal type comprises a predetermined number of manual switch operations within a predetermined time interval, and the second signal type comprises a predetermined number of manual switch operations within the predetermined time interval.

4. The seat heating system of claim 1, wherein the microprocessor and the software are configured to stop heating of the second heating element when receiving a signal type that is not the first signal type or the second signal type.

5. The seat heating system of claim 1, wherein the microprocessor and the software are configured to discontinue seatback heating after a predetermined time interval has elapsed after starting seatback heating.

6. The seat heating system of claim 1, wherein the electronic controller is configured to receive operating power from the first signal type and from the second signal type.

7. The seat heating system of claim 6, wherein the electronic controller comprises a capacitor electrically connected to receive power from the first signal type, the second signal type, and other signals from the switch, to obtain and store operating power for the electronic controller.

8. A method of operating a seat heating system for a motor vehicle, the seat heating system having at least one seat further including a seat having a first heating element and a seatback having a separate, second heating element, a battery, a switch controlling operation of the first heating element and the second heating element, a battery, a relay array including a first relay electrically connected to the first heating element and a second relay electrically connected to the second heating element, and electrical circuitry operably connecting the first heating element, the second heating element, the relay array, the switch, and the battery; and an electronic controller electrically connected to wiring or at least two of the relays of the relay array, the electronic controller having a microprocessor and software configured to accept power pulses from the switch, the method including steps of
energizing the first heating element and the second heating element responsively to receiving a first signal type from the switch, and
energizing only the second heating element responsively to receiving a second signal type from the switch, and circuitry connecting the electronic controller to individual relays of the relay array, wherein the first signal type comprises a first predetermined number of manual switch operations within a predetermined time interval, and the second signal type comprises a second predetermined number of manual switch operations different from the first predetermined number of manual switch operations within the predetermined time interval.

9. The method of claim 8, further comprising a step of stopping heating of the second heating element when receiving a signal type that is not the first signal type or the second signal type.

10. The method of claim 8, further comprising a step of discontinuing seatback heating after a predetermined time interval has elapsed after starting seatback heating.

11. The method of claim 8, further comprising a step of utilizing the first signal type and the second signal type to provide operating power for the electronic controller.

12. The method of claim 11, further comprising a step of providing a capacitor to store operating power for the electronic controller, and electrically connecting the capacitor to receive power from signals from the switch.

13. A method of operating a seat heating system for a motor vehicle, the seat heating system having at least one seat further including a seat having a first heating element and a seatback having a separate, second heating element, a battery, a switch controlling operation of the first heating element and the second heating element, a battery, a relay array including a first relay electrically connected to the first heating element and a second relay electrically connected to the second heating element, and electrical circuitry operably connecting the first heating element, the second heating element, the relay array, the switch, and the battery; and an electronic controller electrically connected to wiring or at least two of the relays of the relay array, the electronic controller having a microprocessor and software configured to accept power pulses from the switch, the method including steps of independently controlling the first heating element and the second heating element.
